(19) United States
(12) Patent Application Publication
(10) Pub. No.: US 2026/0019698 A1
(43) Pub. Date: Jan. 15, 2026

(54) IMAGE PROCESSING APPARATUS, AND CONTROL METHOD OF IMAGE PROCESSING APPARATUS

(71) Applicant: CANON KABUSHIKI KAISHA, Tokyo (JP)

(72) Inventor: MAKOTO YOKOZEKI, Kanagawa (JP)

(21) Appl. No.: 19/337,447

(22) Filed: Sep. 23, 2025

Related U.S. Application Data
(63) Continuation of application No. PCT/JP2024/011190, filed on Mar. 22, 2024.

(30) Foreign Application Priority Data
Mar. 29, 2023 (JP) 2023-053893

(51) Int. Cl. H04N 23/611; G06V 20/52; G06V 40/16; H04N 23/67

(52) U.S. Cl. CPC H04N 23/611; G06V 20/52; G06V 40/166; G06V 2201/08; H04N 23/675

(57) ABSTRACT

In a case where a first setting is set, a determination unit determines a main subject region while setting, as a main subject, a subject of which a first subject has been detected by a first detection unit, in priority to a subject of which the first subject has not been detected by the first detection unit, and in a case where a second setting is set, the determination unit determines a main subject region while setting, as a main subject, a subject of which the first subject has not been detected by the first detection unit, and of which the second subject has been detected by a second detection unit, in priority to a subject of which the first and second subjects have not been detected.

### CROSS-REFERENCE TO RELATED APPLICATIONS

This application is a Continuation of International Patent Application No. PCT/JP2024/011190, filed March 22, 2024, which claims the benefit of Japanese Patent Application No. 2023-053893, filed March 29, 2023, both of which are hereby incorporated by reference herein in their entirety.

### BACKGROUND

### Field of the Technology

The present disclosure relates to an image processing apparatus that detects a predefined subject, and sets a main subject region in which focusing and exposure adjusting are performed, and a control method of the image processing apparatus.

### Description of the Related Art

Image processing methods of detecting a specific subject from an image more stably include a method of detecting an upper body or a head portion of a human.

Japanese Patent Laid-Open No. 2022-51280 discloses a method of detecting and tracking a head portion of a subject whose face is detected when the subject faces the front, even in a case where the subject faces backward using the above-described technique of detecting an upper body or a head portion of a human. In Japanese Patent Laid-Open No. 2022-51280, it is possible to appropriately select a main subject even in a case where a plurality of humans appears.

Nevertheless, Japanese Patent Laid-Open No. 2022-51280 has originally not expected a case where a face-undetectable human such as a goggle-wearing-human or a mask-wearing human gets into a field angle.

### SUMMARY

The present disclosure has been devised in view of the above-described problematic points, and is directed to providing an image processing apparatus that can appropriately select a main subject reflecting the intention of the user more, and a control method of the image processing apparatus.

To solve the above-described issues, an image processing apparatus according to the present disclosure includes a first detection unit for detecting a first subject from an image, a second detection unit for detecting a second subject different from the first subject from the image, a determination unit for determining a main subject region that is a region of a main subject, from at least one of detection results obtained by the first detection unit and the second detection unit, and a setting unit for receiving switching between a first setting and a second setting, based on an operation from a user. In a case where the first setting is set by the setting unit, the determination unit determines a main subject region while setting, as a main subject, a subject of which the first subject has been detected by the first detection unit, in priority to a subject of which the first subject has not been detected by the first detection unit. In a case where the second setting is set by the setting unit, the determination unit determines a main subject region while setting, as a main subject, a subject of which the first subject has not been detected by the first detection unit, and of which the second subject has been detected by the second detection unit, in priority to a subject of which the first subject and the second subject have not been detected

According to the present disclosure, it becomes possible to appropriately select a main subject reflecting the intention of the user more.

Features of the present disclosure will become apparent from the following description of embodiments with reference to the attached drawings.

### BRIEF DESCRIPTION OF THE DRAWINGS

FIG. 1 is a block diagram illustrating a configuration of an imaging apparatus including an image processing apparatus image processing apparatus according to a first embodiment.

FIG. 2 is a flowchart illustrating main subject determination processing according to the first embodiment.

FIG. 3 is a flowchart illustrating main subject candidate determination processing according to the first embodiment.

FIG. 4 is a flowchart illustrating main subject locking determination processing according to the first embodiment.

FIG. 5 is a flowchart illustrating main subject determination processing according to the first embodiment.

FIG. 6 is a flowchart illustrating detection weight setting processing according to the first embodiment.

FIG. 7A is a diagram illustrating a priority weight related to a position and a size according to the first embodiment.

FIG. 7B is a diagram illustrating a priority weight related to a position and a size according to the first embodiment.

FIG. 8A is a diagram illustrating a detection type weight according to a second embodiment.

FIG. 8B is a diagram illustrating a detection type weight according to the second embodiment.

FIG. 8C is a diagram illustrating a detection type weight according to the second embodiment.

FIG. 9A is a diagram illustrating an effect according to the first embodiment.

FIG. 9B is a diagram illustrating an effect according to the first embodiment.

FIG. 9C is a diagram illustrating an effect according to the first embodiment.

FIG. 9D is a diagram illustrating an effect according to the first embodiment.

FIG. 9E is a diagram illustrating an effect according to the first embodiment.

FIG. 9F is a diagram illustrating an effect according to the first embodiment.

FIG. 9G is a diagram illustrating an effect according to the first embodiment.

FIG. 10 is a flowchart illustrating main subject candidate determination processing according to the second embodiment.

FIG. 11 is a flowchart illustrating detection weight setting processing according to the second embodiment.

FIG. 12A is a diagram illustrating an effect according to the second embodiment.

FIG. 12B is a diagram illustrating an effect according to the second embodiment.

FIG. 12C is a diagram illustrating an effect according to the second embodiment.

FIG. 12D is a diagram illustrating an effect according to the second embodiment.

FIG. 12E is a diagram illustrating an effect according to the second embodiment.

FIG. 12F is a diagram illustrating an effect according to the second embodiment.

FIG. 13 is a block diagram illustrating a configuration of an image processing apparatus including an automatic focusing device according to the second embodiment of the present disclosure.

FIG. 14 is a flowchart illustrating main subject determination processing according to the second embodiment.

### DESCRIPTION OF THE EMBODIMENTS

Hereinafter, the best mode for carrying out the present disclosure will be described in detail with reference to the accompanying drawings.

As described above, Japanese Patent Laid-Open No. 2022-51280 has originally not expected a case where a face-undetectable human such as a goggle-wearing-human or a mask-wearing human gets into a field angle. In view of the foregoing, it is considered to set, as a main subject, a subject whose face has never been detected, as long as a head portion of the subject has been detected, in order to set even a face-undetectable human such as a goggle-wearing-human or a mask-wearing human, as a main subject. Nevertheless, it is impossible to determine whether the subject is facing backward in the above-described situation, and thus, when a subject of which only a head portion has been detected is excluded from main subject candidates as in Japanese Patent Laid-Open No. 2022-51280, even in a case where a face-undetectable human is facing the front, the human is excluded from main subject candidates.

In view of the foregoing, the present disclosure is characterized by solving the above-described issues by enabling a user to set a subject to be set as a main subject candidate.

### <First Embodiment>

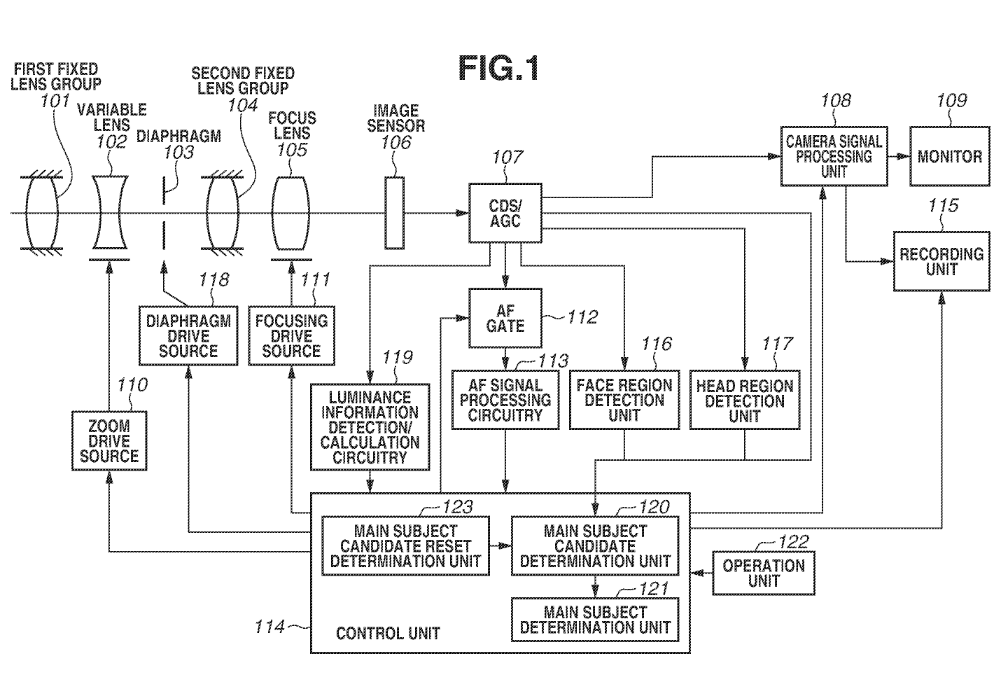

FIG. 1 illustrates a configuration of an imaging apparatus such as a video camera including an image processing apparatus according to the first embodiment. In the present embodiment, a video camera will be described as an example, but the present disclosure can be applied to another imaging apparatus such as a digital still camera.

In FIG. 1, an image capturing optical system for forming light from a subject includes a first fixed lens group 101, a variable lens 102 that performs magnification varying by moving in an optical axis direction, a diaphragm 103, a second fixed lens group 104, and a focus lens 105. The focus lens 105 has both a function of correcting the movement of a focal plane that is caused by magnification varying, and a focusing function. An image sensor 106 is a member serving as an image sensor, and includes a charge-coupled device (CCD) sensor or a complementary metal-oxide semiconductor (CMOS) image sensor. The image sensor 106 includes a plurality of pixel portions arrayed in a matrix. Light beams having passed through the image capturing optical system form an image on a light receiving surface of the image sensor 106, and are converted into signal charges corresponding to an incident light amount, by a photodiode (photoelectric conversion unit) included in each pixel portion. When a moving image is captured, an electric signal of each frame is periodically output. The image sensor 106 according to the present embodiment holds a plurality of photodiodes (will be described as two photodiodes in the present embodiment) in one pixel, to perform generally-known image capturing plane phase difference autofocus (AF). By separating light beams by a microlens, and forming images by two photodiodes (photodiodes A and B), two signals for image capturing and phase difference detection can be acquired. In the present embodiment, a signal (image signal A + B) obtained by adding signals of the two photodiodes is an image capturing signal, and signals (image signal A, image signal B) of the respective photodiodes are two image signals for phase difference detection (AF).

Because the photodiodes receive light beams having passed through different regions of an exist pupil of an image capturing optical system, the image signal B has a parallax with respect to the image signal A. By calculating correlation between two image signals for AF in an AF signal processing circuitry 113 to be described below, and performing a focus detection of phase difference detection method, an image shift amount and various types of reliability information are calculated. The configuration of an image sensor supporting the image capturing plane phase difference AF is not limited to the configuration in which a plurality of photodiodes is provided in one pixel as in the present embodiment. For example, a plurality of types of focus detection pixels (one photodiode in one pixel) that receive light beams having passed through different regions of an exist pupil of an image capturing optical system can be provided in an image sensor.

A correlated double sampling/auto gain control (CDS/AGC) circuitry 107 samples the output of the image sensor 106, and adjusts a gain. A camera signal processing circuitry 108 performs various types of image processing on an output signal from the CDS/AGC circuitry 107, and generates a video signal. A monitor 109 includes a liquid crystal display (LCD) or the like, and displays a video signal from the camera signal processing circuitry 108. A recording unit 115 records a video signal from the camera signal processing circuitry 108, onto a recording medium such as a magnetic tape, an optical disc, or a semiconductor memory.

A zoom drive source 110 moves the variable lens 102 and a focusing drive source 111 moves the focus lens 105. The zoom drive source 110 and the focusing drive source 111 each include an actuator such as a stepping motor, a direct-current (DC) motor, a vibration type motor, and a voice coil motor.

An AF gate 112 permits passage of signals of regions to be used for focus detection (focus detection regions), among output signals of all pixels from the CDS/AGC circuitry 107. The AF signal processing circuitry 113 generates an AF evaluation value by extracting a high-frequency component from the signals having passed through the AF gate 112. The generated AF evaluation value is output to a control unit 114. The AF evaluation value indicates the sharpness (contrast state) of a video generated based on an output signal from the image sensor 106, and because the sharpness varies depending on a focus state (focus degree) of the image capturing optical system, the AF evaluation value eventually becomes a signal indicating a focus state of the image capturing optical system. Alternatively, the AF signal processing circuitry 113 may calculate correlation between two image signals for AF that are output from the CDS/AGC circuitry 107, using a known phase difference focus detection method, calculate a defocus amount, and output the defocus amount to the control unit 114.

The control unit 114 includes a processor such as a central processing unit (CPU) or a micro processing unit (MPU), and a storage unit such as a memory. The control unit 114 can include a calculation circuitry, and cause the calculation circuitry to execute a part of calculation functions to be performed by the processor. The control unit 114 governs the control of operations of the entire video camera, and also performs AF control of performing focusing by controlling the focusing drive source 111 and moving the focus lens 105 based on an AF evaluation value, a defocus amount, or the like.

A face region detection unit 116 performs known face detection processing on an image signal, and detects a face region of a human in an image capturing screen. That is, the face region detection unit 116 detects a predefined subject from an electric signal. The detection result is transmitted to the control unit 114. Examples of the face region detection processing include a method of extracting a skin color region from gradation colors of pixels represented by image data, and detecting a face based on a degree of matching with a face outline plate prepared in advance. Aside from this, there is a method of performing face detection by extracting a face feature point such as an eye, a nose, or a mouth using a known pattern recognition technique, or the like, but the present disclosure is not limited by the method of face detection processing, and any method can be used. The present embodiment also selects a face as a first part of a subject that is to be detected, but the first part is only required to be a part of the subject and can be another part such as an arm or a leg. Known methods similar to the above-described method for the face can also be used in the detection of these other parts.

A head region detection unit 117 detects a predetermined region from an image, with a targeted subject region being set to a head region. That is, the head region detection unit 117 detects a predefined subject (here, head region) from an electric signal. In the head region detection according to the present embodiment, a head region is detected from image data based on learning data, and a detection result is transmitted to the control unit 114. In the present embodiment, a head region will also be described as a block to be detected, but the block is only required to be a block for detecting a region of a human such as a head region other than a face, an upper body region, a body trunk region, or a whole-body region. In the present embodiment, a head region is selected as a second part, but the second part can also be another part serving as a part of the subject as long as the part is a part other than the first part.

The control unit 114 transmits information to the AF gate 112 to set a focus detection region to a position where the focus detection region includes a face region and a head region in an image capturing screen, based on a detection result of the face region detection unit 116 and a detection result of the head region detection unit 117. In the first embodiment, in a case where a face is detected, a focus detection region is set based on the position/size of a face region. In contrast, in a case where a face is not detected and only a head region is detected, a focus detection region is set based on the position/size of a head region. In a case where only a head region is detected, a position/size of a face region of a subject can be estimated from a head region detection result, and a focus detection region can also be set based on the estimated position/size.

The control unit 114 includes a main subject candidate determination unit 120, a main subject determination unit 121, and a main subject candidate reset determination unit 123. The main subject candidate determination unit 120 determines whether a subject can be a main subject candidate, based on detection results of a face region detected by the face region detection unit 116, and a head region detected by the head region detection unit 117. Then, a main subject is selected from among subjects determined to be main subject candidates by main subject determination processing to be described below, processing of superimposing frame display indicating a face region and a head region, on a captured image is performed, and the frames and the captured image are displayed on the monitor 109.

In the present embodiment, the control unit 114 performs focusing control based on a focus detection result (information such as an AF evaluation value and a defocus amount) obtained from a focus detection region set to a face region and a head region of the main subject selected by the main subject determination unit 121. Alternatively, focusing control can be performed using a focus detection result of a face region and a head region of a subject other than a main subject determined by the main subject candidate determination unit 120 to be a main subject candidate. The focusing control is a known technique, and thereby the description of the details of the control will be omitted. The focusing control is executed in accordance with a computer program stored in the control unit 114.

A diaphragm drive source 118 includes an actuator for driving the diaphragm 103, and a driver thereof. To acquire a luminance value of a photometric frame in a screen, a photometric value is acquired by a luminance information detection/calculation circuitry 119 from a signal read out by the CDS/AGC circuitry 107, and measured photometric values are normalized by calculation. The control unit 114 then calculates a difference between the photometric value and a target value set to obtain appropriate exposure. Thereafter, a corrected drive amount of the diaphragm is calculated from the calculated difference, and the control unit 114 controls the driving of the diaphragm drive source 118. In the present embodiment, the description will be given assuming that the photometric frame set in the screen is fixed, but the photometric frame can also be set to track a face region or a head region of the above-described main subject.

An operation unit 122 serves as various operation members functioning as an input unit for receiving operations from the user. The operation unit 122 includes at least a part of the following operation units: a shutter button, a main electronic dial, a power switch, a sub-electronic dial, a cross key, a SET button, a movie button, an AF locking button, a zoom button, a reproduction button, a menu button, a touch bar, and a touch panel.

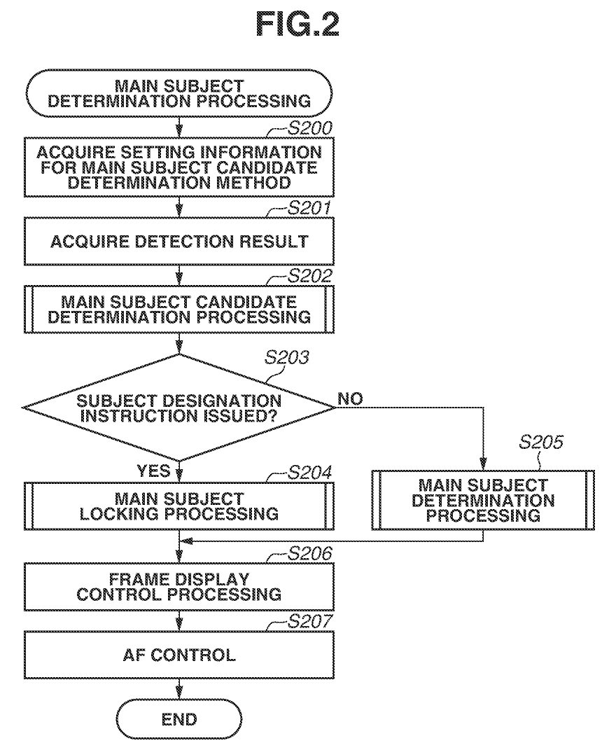

Next, a flow of main subject determination processing according to the present embodiment will be described with reference to FIGS. 2-5.

First of all, the overall flow of the main subject determination processing will be described with reference to FIG. 2. The processing is executed in accordance with a computer program stored in the control unit 114. A system that performs a series of processes according to the present embodiment in synchronization with an image capturing cycle is assumed, but the system is not limited thereto.

First of all, in step S200, the control unit 114 acquire setting information on a main subject candidate determination method set by the user, from a memory in the control unit 114. Main subject candidate determination methods settable in the present embodiment include the following two determination methods.

The first determination method is based on the thought that a subject whose first part (face) has never been detected since the subject has entered a frame cannot become a main subject. That is, the first determination method is a determination method of setting only a subj ect whose first part (face) has been detected at least once in a plurality of frames within a predetermined period, as a main subject candidate (hereinafter, referred to as a first setting).

The second determination method is based on the thought that even a subject whose first part (face) has never been detected in a plurality of frames within a predetermined period since the subject has entered a frame can become a main subject, to capture images of a subject whose first part (face) is undetectable due to goggles or the like. That is, the second determination method is a determination method of setting, in a case where either a first part (face) or a second part (head) different from the first part is detected, a subject having the detected part, as a main subject candidate (hereinafter, referred to as a second setting).

Next, in step S201, the control unit 114 acquires a face detection result and a head detection result from the face region detection unit 116 and the head region detection unit 117. In the present embodiment, position information, size information, gradient information, or detection reliability degree information of a face or head region is acquired as a face or head detection result, but the face or head detection result is not limited to this.

The control unit 114 also determines which face and which head belong to a same person, from the acquired face detection result and the head detection result. The control unit 114 also determines, based on the position or the size, a human acquired in the previous frame to which a face detection result and a head detection result acquired in the current frame are identical. The human determined to have the detection result identical to the detection result in the previous frame is assigned the same ID of a detection result of the same human in the pervious frame, and the subsequent processing is performed.

Next, in step S202, the main subject candidate determination unit 120 performs main subject candidate determination processing. In the main subject candidate determination processing, the main subject candidate determination unit 120 determines whether each person is a candidate subject that can be a main subject on which a focus is to be put, and for which brightness is to be controlled, from among detected persons.

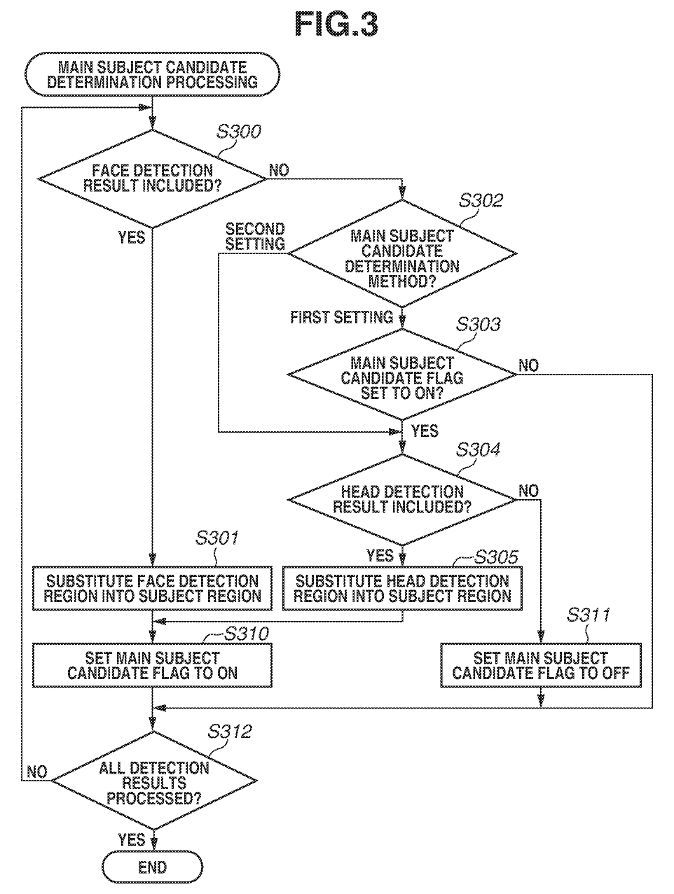

The details of the main subject candidate determination processing will be described below with reference to FIG. 3.

Next, in step S203, the control unit 114 determines whether an instruction to designate a subject has been issued by the user via the operation unit 122. In a case where it is determined that an instruction to designate a subject has been issued, the processing proceeds to step S204. In a case where it is determined that an instruction to designate a subject has not been issued, the processing proceeds to step S205. The operation unit 122 can use a method of designating a subject by a touch panel, or can use a method of designating a subject by detecting a direction or press like a cross key.

Next, in step S204, the main subject determination unit 121 performs main subject locking processing. The main subject locking processing is processing of determining a region of a main subject based on a detection result acquired in step S201, and information regarding a subject designation instruction acquired in step S203, irrespective of a result of a main subject candidate determined in step S202.

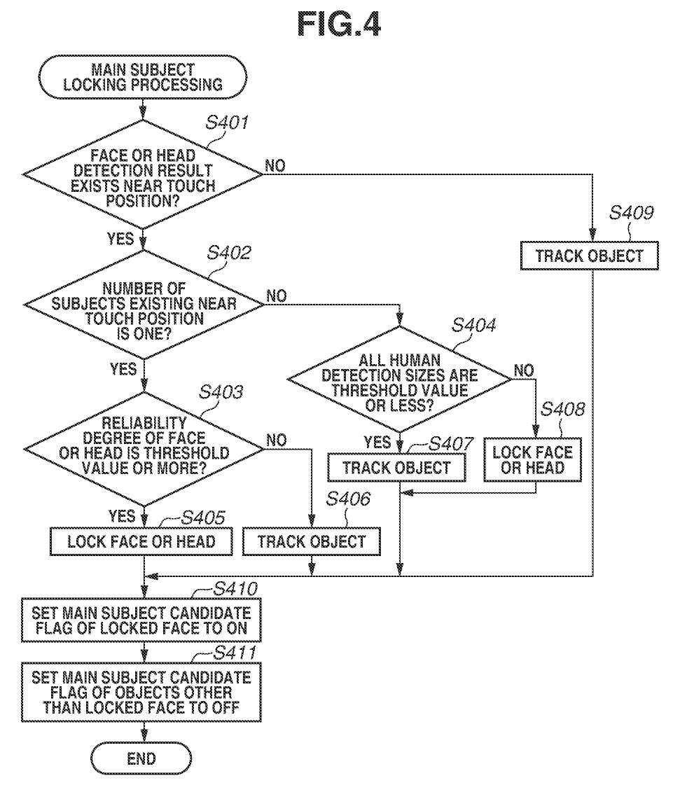

The details of the main subject locking processing will be described below with reference to FIG. 4.

Next, in step S205, main subject determination processing of determining a main subject from among main subject candidates determined based on the processing of the main subject candidate determination unit is performed.

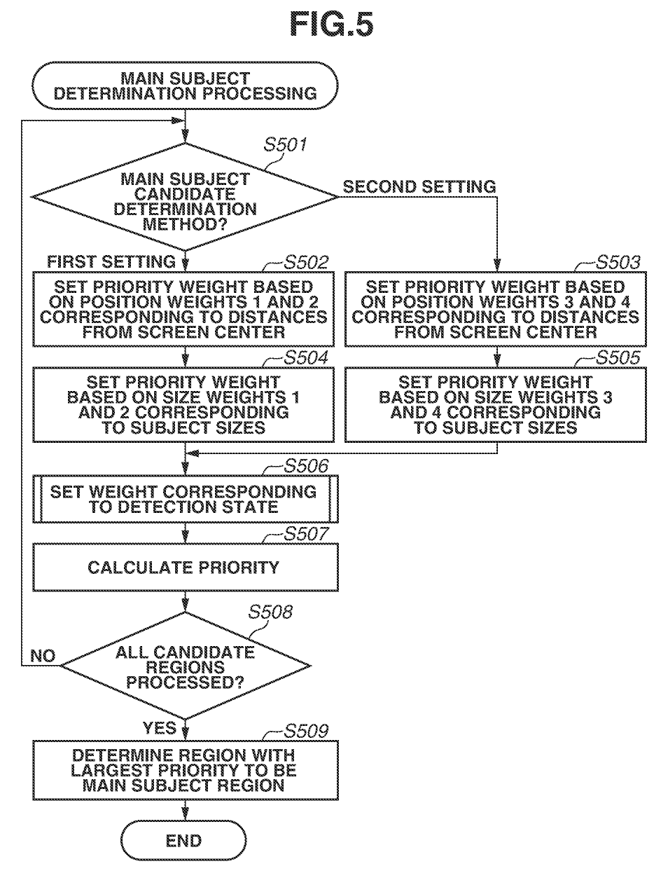

The details of the main subject determination processing will be described below with reference to FIG. 5.

Next, in step S206, the control unit 114 performs frame display control processing on the monitor 109. Specifically, the control unit 114 displays a frame indicating that a subject is a main subject, in the region of the main subject determined in steps S204 and S205, with being superimposed on a face or head portion. The control unit 114 also displays a frame indicating that a subject is a sub subject, on a face or head portion of a subject who has been determined by the main subject candidate determination unit 120 to be a mainsubject candidate, but has not been determined to be a main subject (subject determined to be a sub subject). In the present embodiment, in a case where a main subject is locked in step S204, frame display indicating that a main subject has been locked is performed for the user, whereas a frame is not displayed on a face or head portion of a human who has been determined to be a main subject candidate but has not been determined to be a main subject.

Next, in step S207, the control unit 114 sets a subject region of the main subject in the AF gate 112 and performs AF control based on an AF evaluation value acquired from the AF signal processing circuitry 113. A method of using a contrast evaluation value indicating the contrast or sharpness of a subj ect, as the above-described AF evaluation value, or a method can also be employed of using a defocus amount up to an in-focus position calculated based on a phase difference, as the above-described AF evaluation value.

Next, the details of the subject candidate determination processing will be described with reference to FIG. 3.

First of all, in step S300, the main subject candidate determination unit 120 of the control unit 114 acquires a detection result of a first human (hereinafter, will be referred to as a targeted human) from the detection result acquired in step S201 to determine whether a face has been detected,. In the present embodiment, a detection result includes position and size information of a region of a face, a head, or the like that has been detected in an image, and an ID for distinguishing from other parts, and whether a face has been detected is determined based on the ID.

In a case where it is determined that a face has been detected, the processing proceeds to step S301. In a case where it is determined that a face has not been detected, the processing proceeds to step S302.

Next, in step S301, the control unit 114 stores information (e.g., position, size) regarding the region of the detected face, as subject region data of the target human, and advances the processing to step S310.

Next, in step S302, the control unit 114 refers to the setting information of the main subject candidate determination method that has been acquired in step S200. In a case where the setting information indicates the first setting, the processing proceeds to step S303. In a case where the setting information indicates the second setting, the processing proceeds to step S304.

Next, in step S303, the control unit 114 determines, based on a main subject candidate flag, whether a subject has already been determined to be a main subject candidate in the previous main subject candidate determination processing. In a case where it is determined that a subject has already been determined to be a main subject candidate in the previous main subject candidate determination processing (main subject candidate flag is set to ON), the processing proceeds to step S304. In contrast, in a case where it is determined that a subject has never been determined to be a main subject candidate including the previous frame (never within a predetermined period) (main subject candidate flag is set to OFF), the processing proceeds to step S312.

Next, in step S304, it is determined whether a head detection result is included in the detection result of the target human. In a case where a head detection result is included, the processing proceeds to step S305. In a case where a head detection result is not included, the processing proceeds to step S311.

Next, in step S305, information (e.g., position, size) regarding the region of the detected head is stored as subject region data of the target human, and the processing proceeds to step S310.

In a case where a head detection region is stored as subject region data of the target human in step S305, it is effective to shift the position of a subject region slightly downward (body direction with respect to the head) with respect to the position of the stored head detection region. This is because the head region detection unit 117 can detect a human even when the human faces backward or sideways, whereas the back of the head and the temporal region of the head of the human easily become low contrast as compared with the face, and are difficult to be focused, and a too-bright setting as the entire subject might be set by controlling the brightness based on a hair portion of the back of the head. Specifically, by shifting the position of a subject region in about a 1/4 body direction of a head detection size, not only a hair portion of the back of the head but also a collar portion are included, and a possibility that the contrast of a neck and a collar can be caught increases, and improvement in focusing accuracy and exposure control accuracy can be expected.

Next, in step S310, a face detection region or a head detection region is substituted into a subject region in step S301 or S305 and a subject has become a main subject candidate, and thus the main subject candidate flag is set to ON, and the processing proceeds to step S312.

In contrast, in step S311, because it is a case where neither a face detection result nor a head detection result is included in a region determined to be a main subject candidate region in the previous frame, a subject is determined to be not a main subject candidate, the main subject candidate flag is set to OFF, and the processing proceeds to step S312. The timing at which the main subject candidate flag is set to OFF can be a timing at which a face detection or head detection result has become nonexistent once, or can be a timing at which the nonexistence of a face detection or head detection result continues several times (predetermined number of frames).

Next, in step S312, it is determined whether the check of all detection results acquired in step S201 has ended. In a case where the check of all detection results has ended, the processing ends. In a case where the check of all detection results has not ended, the processing returns to step S300 and the next detection result is set as a target human.

In a case where the setting information indicates the first setting, a subject is determined to be a main subject candidate only in a case where it is determined that a face has been detected in the processing in step S300, or only in a case where a head has been detected in step S304 under the condition that the main subject candidate flag is set to ON in the processing in step S303. The above-described condition realizes the thought that a subject whose face has never been detected since the subject has entered a frame cannot become a main subject. This is because a subject whose face has never been detected is a subject who does not look toward a camera, and is unlikely to be a subject on which a focus is desired to be put, and for which brightness is desired to be controlled, as a main subject in image capturing.

In addition, in a case where the setting information indicates the second setting, a subject is determined to be a main subject candidate only in a case where it is determined that a face has been detected in the processing in step S300, or only in a case where it is determined that a head has been detected in step S304. The above-described condition realizes the thought that even a subject whose face has never been detected since the subject has entered a frame can also become a main subject. Because the second setting is a setting to be used in a case where an image of a face-undetectable subject due to goggles or a mask is desired to be captured, whether a face has ever been detected is irrelevant. This is also because a subject of which only a head has been detected might be a subject on which a focus is desired to be put, and for which brightness is desired to be controlled, as a main subject in image capturing.

Through the above-described processing, in a case where the setting information indicates the first setting, it is possible to prevent an unnecessary human who is not to be determined to be a main subject, from being determined to be a main subject candidate, among faces or heads detected in a screen. Furthermore, while enabling the prevention of focusing and brightness control on and for an unintended human, in a case where the setting information indicates the second setting, a face-undetectable subject due to goggles can also become a main subject candidate. With this configuration, a possibility that a focus can be put on and brightness can be controlled for a human intended by the user.

Next, a main subject locking determination method to be performed by the main subject determination unit 121 of the control unit 114 will be described with reference to FIG. 4.

First of all, in step S401, it is determined whether a face detection result or a head detection result, which is a detection result acquired in step S201, exists within a predetermined range from a position (touch position in the case of a touch panel) within an image (within a screen, XY-plane) of a subject that has been received via the operation unit 122. The above-described predetermined range can be a range within the size of a detected face or a head, or can include a region outside the size of a detected face or a head, such as a range within a double distance of the size of a face or a head. In addition, a depth direction (Z direction vertical to the XY plane) from the current subject can also be within the range of a predetermined distance. In a case where a face detection result or a head detection result exists within the predetermined range, the processing proceeds to step S402. In a case where a face detection result or a head detection result does not exist within the predetermined range, the processing proceeds to step S409.

Next, in step S402, it is determined whether there is a plurality of face detection results or head detection results determined to exist within the predetermined range from the touch position. In a case where it is determined that the number of subjects is only one, the processing proceeds to step S403. In a case where it is determined that a plurality of subjects exists, the processing proceeds to step S404.

Next, in step S403, it is determined whether a reliability degree of a face detection result or a head detection result determined to exist within the predetermined range from the touch position is a threshold value or more. In a case where it is determined that a reliability degree is a threshold value or more, the processing proceeds to step S405. In a case where it is determined that a reliability degree is smaller than the threshold value, the processing proceeds to step S406.

Next, in step S404, it is determined whether sizes of all face detection results and head detection results determined to exist within the predetermined range from the touch position are a threshold value or less. In a case where it is determined that the sizes are a threshold value or less, the processing proceeds to step S407. In a case where it is determined that a detection result with a size larger than or equal to the threshold value exists (NO in step S404), the processing proceeds to step S408.

Next, in steps S405 and S408, a face detection result or a head detection result closest to a touch position existing within the range of a touched position is locked. In a case where a face detection result is included, the face detection result is used, and in a case where a face detection result is not included and a head detection result is included, the head detection result is used.

Next, in steps S406, S407, and S409, an object other than the face or the head of a human is tracked (hereinafter, referred to as object tracking) by extracting a feature of a subject based on a touch position.

Next, in step S410, the locked subject is determined to be a main subject, and a main subject candidate flag of a locked human is set to ON.

Next, in step S411, objects other than the locked subject are prevented from becoming candidates by setting main subject candidate flags of objects other than the locked human to OFF, and the processing ends.

The reason why object tracking is performed in step S406 when it is determined in step S403 that a reliability degree is a threshold value or less is that, in a case where a reliability degree of head detection is low such as a case where a part of the head goes out of a frame, a detection position and size become unstable and AF can become unstable.

Thus, in a case where a face has been detected or a reliability degree of head detection is low, a subject existing at a position designated by the user is temporarily tracked as an object by performing region designation by tracking that uses color information and luminance information that are obtained at the time of touch. It is also possible to reduce the possibility of unstable AF by switching a tracking target to the face or the head, when a face or a head with a high reliability degree is detected in the vicinity during tracking,.

In addition, the reason why object tracking is performed in step S404 in a case where a plurality of face or head detection results with a small size exist within the predetermined range from the touch position is that an unintended human is highly likely to be set as a tracking target due to a shift of a touch position from the position designated by the user. Thus, a subject existing at the position designated by the user is temporarily tracked as an object, and then, in a case where a face or head with a predetermined size or more is detected within the predetermined range, a tracking target is switched to the face or the head. With this configuration, it is possible to avoid focusing on an unintended human.

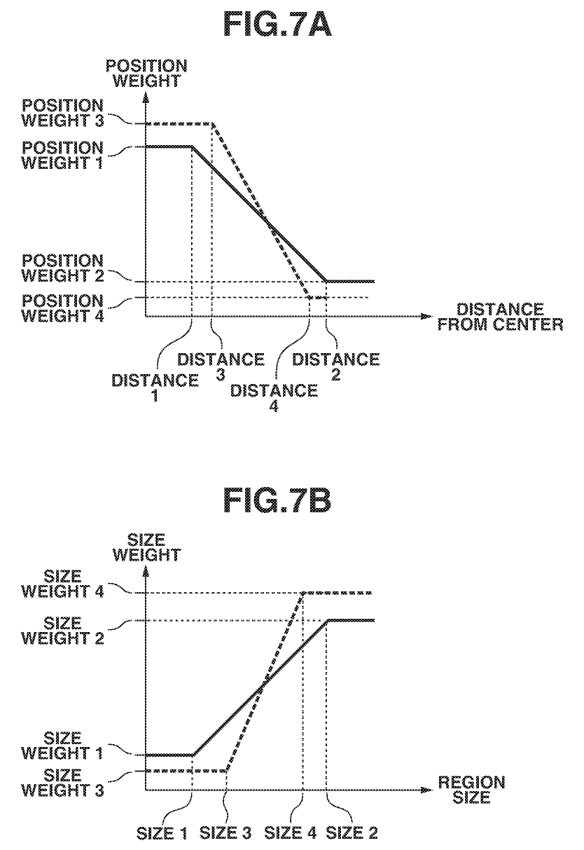

Next, main subject determination processing to be performed by the main subject determination unit 121 in step S205 for a main subject candidate region will be described with reference to FIGS. 5, 7A, and 7B.

First of all, in step S501, the main subject determination unit 121 refers to the setting information of the main subject candidate determination method that has been acquired in step S200, and in a case where the setting information indicates the first setting, the processing proceeds to step S502. In a case where the setting information indicates the second setting, the processing proceeds to step S503.

Next, in step S502, a priority weight regarding a position is set based on position weights 1 and 2 corresponding to distances from a screen center of a main subject candidate region, and the processing proceeds to step S504.

In contrast, in step S503, a priority weight regarding a position is set based on position weights 3 and 4 corresponding to distances from the screen center of the main subject candidate region, and the processing proceeds to step S505.

Here, the above-described position weights 1, 2, 3, and 4 will be described with reference to FIG. 7A.

FIG. 7A illustrates how a position weight is calculated in accordance with a distance from a center position.

A solid line in the drawing indicates a graph for calculating a priority weight to be set in step S502, and a dotted line indicates a graph for calculating a priority weight to be set in step S503.

In a case where the setting information of the main subject candidate determination method indicates the first setting, a weight regarding a position becomes the position weight 1 until a distance from the screen center becomes a distance 1, and the position weight 1 linearly decreases to the position weight 2 until the distance 1 becomes a distance 2. In a case where a distance from the screen center is the distance 2 or more, a weight regarding a position is fixed at the position weight 2.

In a case where the setting information of the main subject candidate determination method indicates the second setting, a weight regarding a position becomes the position weight 3 until a distance from the screen center becomes a distance 3, and the position weight 3 linearly decreases to the position weight 4 until the distance 3 becomes a distance 4. In a case where a distance from the screen center is the distance 4 or more, a weight regarding a position is fixed at the position weight 4.

Next, in step S504, a weight corresponding to a size of the main subject candidate region is set, and the processing proceeds to step S506.

The above-described size weights 1, 2, 3, and 4 will be described with reference to FIG. 7B.

FIG. 7B illustrates how a size weight is calculated in accordance with a size of the main subject candidate region.

A solid line in the drawing indicates a graph for calculating a priority weight to be set in step S504, and a dotted line indicates a graph for calculating a priority weight to be set in step S505.

In a case where the setting information of the main subject candidate determination method indicates the first setting, a weight regarding a size becomes the size weight 1 in a case where a size of a detection region is a size 1 or less, and the size weight 1 linearly increases to the size weight 2 until the size 1 becomes a size 2. In a case where a size is the size 2 or more, a weight regarding a size is fixed at the size weight 2.

In a case where the setting information of the main subject candidate determination method indicates the second setting, a size weight becomes the size weight 3 in a case where a size of a detection region is a size 3 or less, and the size weight 3 linearly increases to the size weight 4 until the size 3 becomes a size 4. In a case where a size is the size 4 or more, a weight regarding a size is fixed at the size weight 4.

In a case where the setting information of the main subject candidate determination method indicates the second setting, a subject of which only a head is detected is also a main subject candidate, the number of main subject candidate regions can thus become larger than that in a case where the setting information of the main subject candidate determination method indicates the first setting. Thus, the possibility of determining an unintended subject to be a main subject also becomes high. By considering that an image of a main subject is captured in a relatively larger size and at a relatively center, as illustrated in FIGS. 7A and 7B, a photographer sets a higher weight to a subject with a larger size at a position closer to the center as compared with the case where the setting information of the main subject candidate determination method indicates the first setting. With this configuration, it becomes possible to avoid determining an unintended subject to be a main subject.

Regarding the position weights 1 to 4, the distances 1 to 4, the size weights 1 to 4, and the sizes 1 to 4 in the drawings, a weight of a subject closer to the screen center becomes larger in a case where the setting information indicates the second setting, than that set in a case where the setting information indicates the first setting. Furthermore, as long as a larger weight is set to a subject with a larger size, the shape, the number of change points, and positions of the graphs illustrated in the drawings are not limited. Furthermore, in the present embodiment, linearly-changing weights, and weights clipped at the smallest and largest as described above are employed, but any weight setting method can be employed as long as the idea is not departing from an idea that a larger weight is set as a distance to the center is smaller, and a larger weight is set as a size becomes larger.

Next, in step S506, a weight corresponding to a detection state is set, and the processing proceeds to step S507.

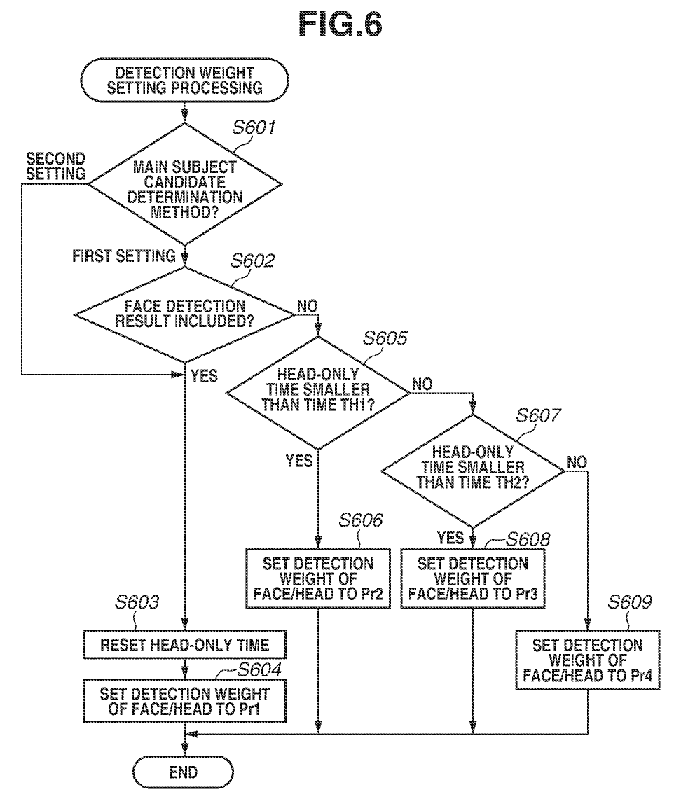

The processing of setting a weight corresponding to a detection state will be described below with reference to FIG. 6.

Next, in step S507, a priority of a target region is calculated in accordance with a weight set in steps S502 to S506.

As an example of a priority calculation method, a priority is calculated by the following formula of adding the above-described weights at a predetermined ratio. priority = a x (position weight) + R x (size weight) + y x (detection weight), where a, (3, and y are coefficients by which the weights are to be multiplied, and can be freely set.

The priority calculation is not limited to the above-described calculation.

Next, in step S508, it is determined whether the check of all the acquired detection results has ended. In a case where the check of all the acquired detection results has ended, the processing ends. In a case where the check of all the acquired detection results has not ended, the processing returns to step S501 and the next detection result is set as a target human.

Next, in step S509, a region with the largest priority is determined to be main subject region from among the priorities of the region that have been calculated in step S507.

When a main subject region is determined, a main subject candidate region with the largest priority can be determined to be a main subject region, each time the processing of each frame is performed, or in a case where a specific main subject candidate region has the largest priority for a predetermined period, the specific main subject candidate region can be determined to be a main subject region.

A main subject candidate flag of a main subject candidate region with a priority smaller than a predetermined threshold value can also be set to OFF in such a manner that the main subject candidate region does not become a main subject candidate region until it is determined again in the subsequent frame that a face detection result is included (when processing result in step S300 becomes YES).

In the present embodiment, weights regarding positions and sizes are used as parameters for determining a main subject. Nevertheless, parameters are not limited to these, and a main subject can be determined in accordance with a reliability degree and a direction of face detection and head detection results, or whether both of a face and a head are detected or either one of them is detected, or the like. In a case where a subject is a subject locked as a main subject in step S204, the subject can also be always determined to be a main subject.

Next, the setting of a weight in accordance with a detection state in step S506 will be described with reference to FIG. 6.

First of all, in step S601, the control unit 114 refers to the setting information of the main subject candidate determination method that has been acquired in step S200. In a case where the setting information indicates the first setting, the processing proceeds to step S602. In a case where the setting information indicates the second setting, the processing proceeds to step S603.

Next, in step S602, the subject candidate determination unit 120 of the control unit 114 acquires a target human from the detection result acquired in step S201, and determines whether a face has been detected.

In the processing in step S602, the determination can be made based on whether the face region detection unit 116 has detected a face, or the determination can be made based on whether a pupil region detection unit (not illustrated) in a face (not illustrated) has detected a pupil, even when a face has not been detected. For example, in a case where a human wears sunglasses, the pupil region detection unit can detect a pupil based on a region detected by the head region detection unit 117 even when the face region detection unit 116 cannot detect a face detection. This is because this case can be considered to be equivalent to a situation where a face is detected.

In a case where it is determined that a face has been detected, the processing proceeds to step S603. In a case where it is determined that a face has not been detected, the processing proceeds to step S605.

Next, in step S603, a timer for holding a period indicating how long a head-only state in which a face is not detected has lasted is reset. The above-described timer is a timer to be compared with times TH1 and TH2 in steps S605 and S607 to be described below.

Next, in step S604, a detection weight of a face/head is set to Prl, and the processing ends.

Next, in step S605, it is determined whether a time of the head-only state in which a face is not detected is smaller than the time TH1. In a case where the time is smaller than the time TH1, the processing proceeds to step S606. In a case where the time TH1 or more has elapsed, the processing proceeds to step S607.

Next, in step S606, a detection weight of a face/head is set to Pr2, and the processing ends.

Next, in step S607, it is determined whether a time of the head-only state in which a face is not detected is smaller than the time TH2. In a case where the time is smaller than the time TH2, the processing proceeds to step S608. In a case where the time TH2 or more has elapsed, the processing proceeds to step S609.

Next, in step S608, a detection weight of a face/head is set to Pr3, and the processing ends.

Next, in step S609, a detection weight of a face/head is set to Pr4, and the processing ends.

The above-described detection weights Pr1 to Pr4 satisfy the relationship of Pr1 > Pr2 > Pr3 > Pr4, and in a case where the main subject candidate determination method has the first setting, the priority of a detection weight is set to a smaller priority as time advances.

As an example, when Pr1 > Pr2 > Pr3 > Pr4 and TH2 > TH1 0 are satisfied, the detection weight Pr1 set in a case where a face is detected becomes the highest, and a subject whose face has been detected is prioritized. Because the detection weight decreases to the detection weight Pr2 when the face becomes undetectable and only a head is detected, if another subject whose face has been detected exists, a higher detection weight is set to the subject whose face has been detected exists, and the possibility that the priority increases become s higher. Furthermore, in a case where a state without a face detection result continues for a predetermined time larger than or equal to the time TH1, the detection weight further decreases to the detection weight Pr3 after the predetermined time elapses. By providing the time threshold value TH2 and the detection weight Pr3, the detection weight becomes the detection weight Pr2 when a face temporarily becomes undetectable and a priority decreases. In contrast, when a face-undetectable state continues for the predetermined period, and a priority decreases, the detection weight becomes the detection weight Pr3. Thus, discrimination can be made therebetween. Furthermore, when a state without a face detection result continues for a time larger than or equal to the time TH2, the detection weight becomes the detection weight Pr4, which is the lowest.

The detection weight Pr4 can be set to a numeral value at which a priority always becomes smaller than a predetermined threshold value in step S509, and by the priority becoming smaller than the threshold value, a subject who faces backward for a long time can be prevented from becoming a main subject irrespective of a position or a size of a region until a face is detected again. With this configuration, it is possible to prevent an unintended subject from being set as a main subject.

As another example, when Pr1 = Pr2 > Pr3 > Pr4 is satisfied, a detection weight equivalent to that of a subject whose face has been detected is calculated during a period up to the time TH1 from the time immediately after the state enters a state in which a face is not detected and only a head is detected. This is to perform control in such a manner that a subject of which only a head is detected is not unintentionally excluded from a main subject, expecting that a face is to be detected again immediately after a head-only state is caused.

In addition, in the above-described example, the detection weight Pr1 is not changed in both of the case where the main subject candidate determination method is in the first setting, and the case where the main subject candidate determination method is in the second setting, but a method can also be considered of setting the detection weight Pr1 to a larger value when the main subject candidate determination method is in the second setting, more than that set when the main subject candidate determination method is in the first setting. This is because a face-undetectable subject might be desired to be prioritized over a face-detectable subject because the user intentionally makes a setting in such a manner that a subject from a head is desired to be selected as a main subject.

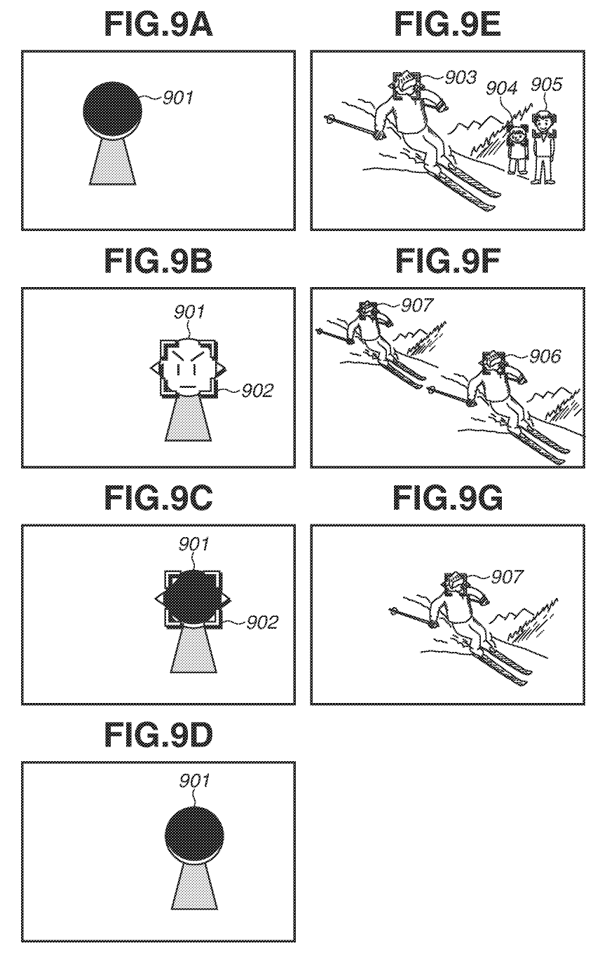

The above-described processing will be described with reference to FIGS. 9A-9G.

FIGS. 9A-9D illustrate a case where the setting of a main subject candidate determination method is the first setting,FIGS. 9E-9G and illustrate a case where the setting of the main subject candidate determination method is the second setting.

FIG. 9A illustrates a scene in which one human 901 facing backward has entered a frame. In such a case, an image of the human 901 is unlikely to be captured as a main subject, and thus region setting and frame display are not performed for a main subject candidate region.

FIG. 9B illustrates the human 901 faces the front. In such a case, the human looks toward a camera, and thus it is considered that an image of the human is captured as a main subject, and region setting for a main subject candidate region is performed and a frame 902 is displayed, for the human 901. In addition, The number of main subject candidates is only one, and thus the human 901 is also automatically selected as a main subject.

FIG. 9C illustrates a case where the human 901 faces backward from the front- faced state in FIG. 9B. In such a case, the human 901 has faced the front once and is considered to be highly likely to face the front again, and thus the human 901 continues to be set as a main subject candidate region. By continuing to set the human 901 as a main subject candidate region, focusing on the human 901 is continued, and it is possible to avoid putting a focus on an unintended region and controlling brightness for the unintended region.

FIG. 9D illustrates a case where the human 901 continues to be in a backward-faced state. In such a case, it is considered that the human 901 is unlikely to be a main subject, a weight corresponding to a detection state is therefore set, by the determination in step S605 or S607, to the detection weight Pr2, Pr3, or Pr4, which is a value lower than that set in a case where a face has been detected (in a case where the human faces the front). Using the weight set in the above-described processing, a priority is calculated in step S507. Nevertheless, a main subject candidate flag of a main subject candidate region whose priority becomes smaller than a predetermined threshold value as a result of priority calculation can be set to OFF in such a manner that the main subject candidate region does not become a main subject candidate region until it is determined again in the subsequent frame that a face detection result is included (until it is determined that a face has been detected in the processing in step S300 (when processing result in step S300 becomes YES).

Through the above-described processing, it is possible to prevent a subject that continues to face backward from continuing to be a main subject candidate, in a case where the user has set the second setting, it is thus possible to avoid putting a focus on an unintended subject region and controlling brightness for the unintended subject region.

FIG. 9E illustrates a scene in which a face-undetectable human wearing goggles, of which a head is detectable exists, and a face-detectable subject exists in the background.

Although a face of a human 903 is undetectable, a head has been detected. In addition, faces and heads of background two humans (human 904 and human 905) have been detected.

In the above-described scene, an equivalent detection weight is set to a subject of which only a head has been detected and a subject of which a face has been detected, a main subject is therefore determined based only on a position and a size. The largest human 903 existing at a position closer to the center is therefore selected as a main subject, and it becomes possible to put a focus on and control brightness for a subject intended by the user. Because a priority is not decreased even when a head-only state continues, it is thus possible to avoid stopping the tracking by head detection after a predetermined time lapse.

As described above, when the second setting is set, by setting the detection weight Pr1 to a larger value than that to be set when the first setting is set, the possibility that the human 904 or the human 905 becomes a main subject gets lower, and the possibility that the human 903 can continue to be a main subject gets higher.

In addition, FIG. 9F illustrates a situation in which image of a human 906 and a human 907 are captured, and both humans are face-undetectable, and only heads have been detected. FIG. 9G illustrates a situation in which the human 906 goes out of the frame from the state in FIG. 9F, and only the human 907 exists, and an image of the human 907 is captured as a main subject.

In FIG. 9F, head tracking of both of the human 907 and the human 908 is not stopped at a specific time by using the determination in step S601. Even after the human 906 goes out of the frame in FIG. 9G, it is thus possible to immediately switch a main subject to the human 907, and it becomes possible to record a natural video in which a focus is put on and brightness is controlled for the human 907.

As described above, it becomes possible to increase the possibility that an intended subject can be set as a main subject in accordance with the setting made by the user, and reduce an image capturing mistake.

### <Second Embodiment>

Next, the second embodiment of the present disclosure will be described. In the above-described first embodiment, a weight is changed in accordance with detection states of a first part (face region) and a part (e.g., head region, upper body region, body trunk region, and whole-body region) different from the first part. In addition, a detection weight to be used in priority calculation is changed in accordance with a detected part of a human.

In recent years, not only human but also various types of subjects such as animals and vehicles have become detectable. There is a technique in which, when a subject set by the user as a subject desired to be prioritized (hereinafter, prioritized subject) and other subjects (hereinafter, non-prioritized subjects) are detected, a focus can be put on and brightness can be controller for a subject intended by the user by setting the prioritized subject as a main subject.

Nevertheless, although a prioritized subject and a non-prioritized subject exist in a screen, it has been necessary to change the setting each time in a situation in which the non- prioritized subject is obviously suitable as a main subject depending on a scene.

The present embodiment is characterized in that, even in the above-described situation, a non-prioritized subject that is likely to be a main subject is set as a main subject depending on a scene without taking the trouble to change the setting, while setting an intended subject as a main subject by prioritizing a subject set by the user.

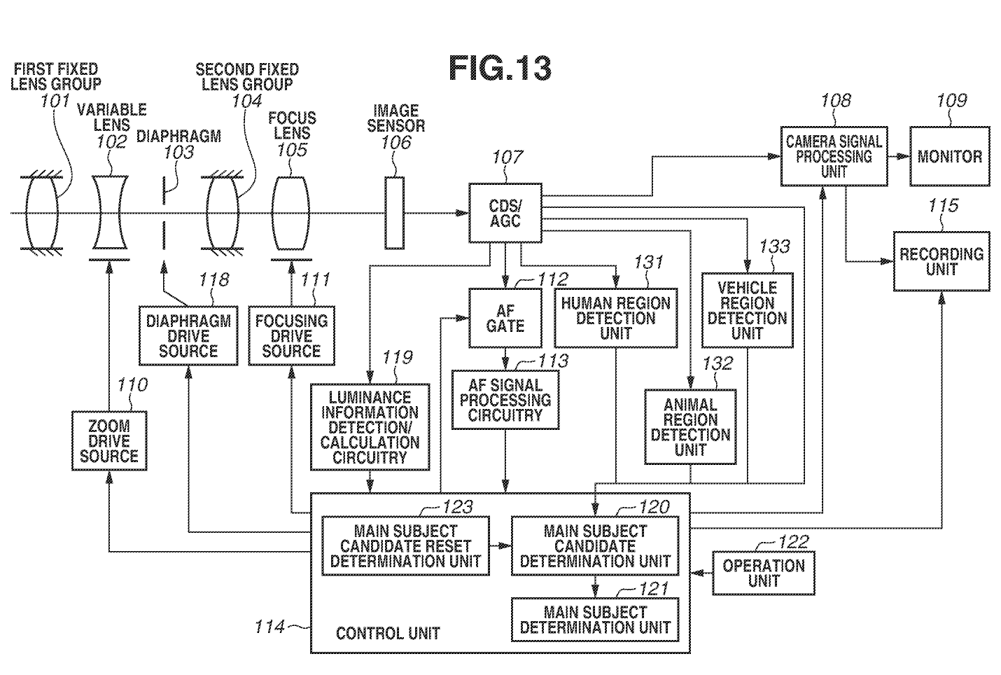

FIG. 13 illustrates a configuration of an imaging apparatus such as a video camera that includes an automatic focusing device according to the second embodiment. Because the blocks assigned the same numbers as those in FIG. 1 are the same as those in FIG. 1, the description will be omitted.

A human region detection unit 131 performs known human detection processing on an image signal, and detects a region of a human within an image capturing screen (face region, head region, upper body region, body trunk region, whole-body region, etc. of human). The detection result is transmitted to the control unit 114. Examples of human region detection processing include, for example, a method of extracting a skin color region from gradation colors of pixels represented by image data, and detecting a human region based on a matching degree with a human outline plate prepared in advance. Another example is a method of detecting a human region from image data based on learning data. Yet another example is a method of performing face detection by extracting face feature points such as an eye, a nose, and a mouth using a known pattern recognition technique, or the like, but the present disclosure is not limited by the method of human detection processing, and any method can be used.

An animal region detection unit 132 performs known animal detection processing on an image signal, and detects an animal region within an image capturing screen (face region, head region, upper body region, body trunk region, whole-body region, etc. of animal). The detection result is transmitted to the control unit 114. Examples of animal region detection processing include, for example, a method of detecting an animal region based on a matching degree with an animal outline plate prepared in advance. Another example is a method of detecting an animal region from image data based on learning data. Yet another example is a method of performing the detection of a face region of an animal by extracting face feature points such as an eye, a nose, and a mouth using a known pattern recognition technique, or the like, but the present disclosure is not limited by the method of human detection processing, and any method can be used.

A vehicle region detection unit 133 performs known vehicle detection processing on an image signal, and detects a vehicle region within an image capturing screen (entirety, driver, wheel, windshield, etc. of a vehicle). The detection result is transmitted to the control unit 114. Examples of vehicle region detection processing include, for example, a method of detecting a vehicle region based on a matching degree with a vehicle outline plate prepared in advance. Another example is a method of detecting a vehicle region from image data based on learning data. Yet another example is a method of performing the detection of a vehicle region by extracting a feature point of a vehicle using a known pattern recognition technique, or the like, but the present disclosure is not limited by the method of vehicle detection processing, and any method can be used.

Next, while the first setting and the second setting are provided in step S200 in the main subject determination processing in FIG. 2 according to the first embodiment, the following three settings are provided in the present embodiment: A first setting (referred to as a third setting to make discrimination from that in the first embodiment) is a setting of prioritizing a human region (hereinafter, human-prioritized setting); A second setting (fourth setting) is a setting of prioritizing a region of an animal such as a dog, a cat, or a bird (hereinafter, animal-prioritized setting); and A third setting (fifth setting) is a setting of prioritizing a region of a vehicle such as an auto, a bike, or a train (hereinafter, vehicle-prioritized setting).

In the present embodiment, the above-described types are detected, but when a setting of switching the type of subject to be detected is provided, the method is not limited to the above-described. Different types of animals can also be set in such a manner that the first setting is for dogs, the second setting is for cats, and the third setting is for birds.

In the present embodiment, all types can also be detected even when whichever setting of the above-described three settings is set, but for example, the top priority is given to a human only in a case where the human-prioritized setting is set, and thus the processing can be performed not to detect a subject other than humans.

In the first embodiment, in step S201, the control unit 114 performs processing of acquiring a face detection result and a head detection result from the face region detection unit 116 and the head region detection unit 117. Nevertheless, in the present embodiment, the control unit 114 performs processing of acquiring a human detection result, an animal detection result, and a vehicle detection result from the human region detection unit 131, the animal region detection unit 132, and the vehicle region detection unit 133, respectively.

In the following description, the processing described in the first embodiment is assigned the same numbers, and the description will be omitted.

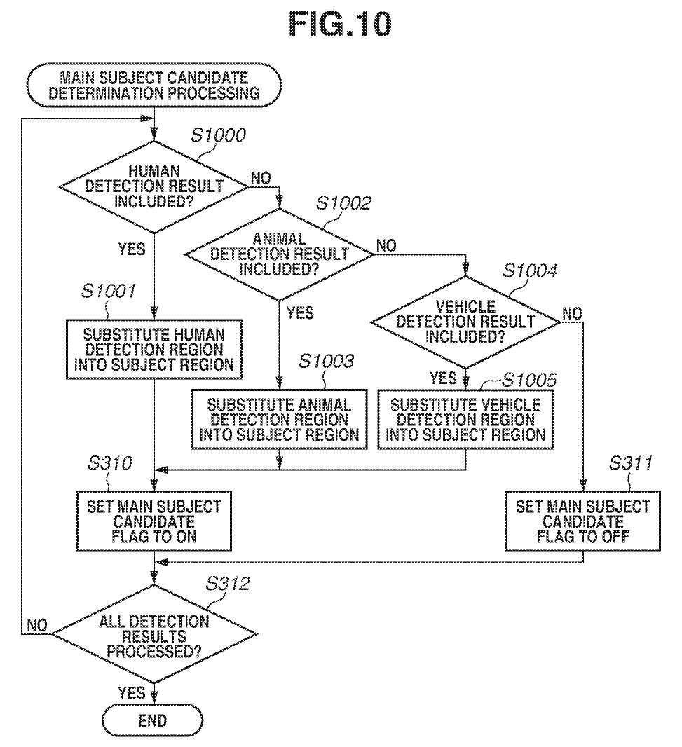

Next, a flow of main subject candidate determination processing, which is a characteristic of the present embodiment, will be described with reference to FIG. 10.

The processing is executed in accordance with a computer program stored in the control unit 114. A system that performs a series of processes according to the present embodiment in synchronization with an image capturing cycle is assumed, but the system is not limited to this.

First of all, in step S1000, the subject candidate determination unit 120 of the control unit acquires a first detection result (hereinafter, referred to as a target subject) from the detection result acquired in step S201, and determines whether a human has been detected.

In a case where it is determined that a human has been detected, the processing proceeds to step S1001. In a case where it is determined that a human has not been detected, the processing proceeds to step S1002.

Next, in step S1001, a region of a detected human is stored as subject region data (e.g., position, size) of the target subject, and the processing proceeds to step S310.

Next, in step S1002, it is determined whether an animal detection result is included in a detection result of the target subject. In a case where an animal detection result is included, the processing proceeds to step S1003. In a case where an animal detection result is not included, the processing proceeds to step S1004.

Next, in step S1003, a region of a detected animal is stored as subject region data of the target subject, and the processing proceeds to step S310.

Next, in step S1004, it is determined whether a vehicle detection result is included in a detection result of the target subject. In a case where a vehicle detection result is included, the processing proceeds to step S1005. In a case where a vehicle detection result is not included, it is determined that nothing is detected in the target region, and the processing proceeds to step S311.

Next, in step S1005, a region of a detected vehicle is stored as subject region data of the target subject, and the processing proceeds to step S310.

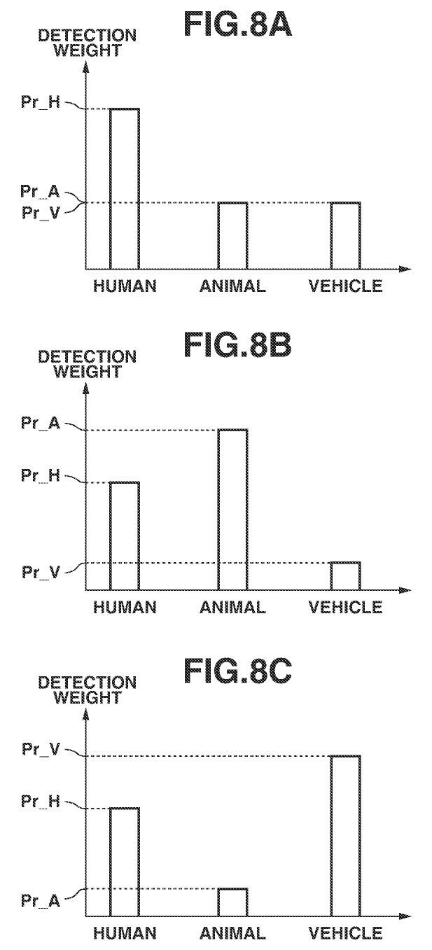

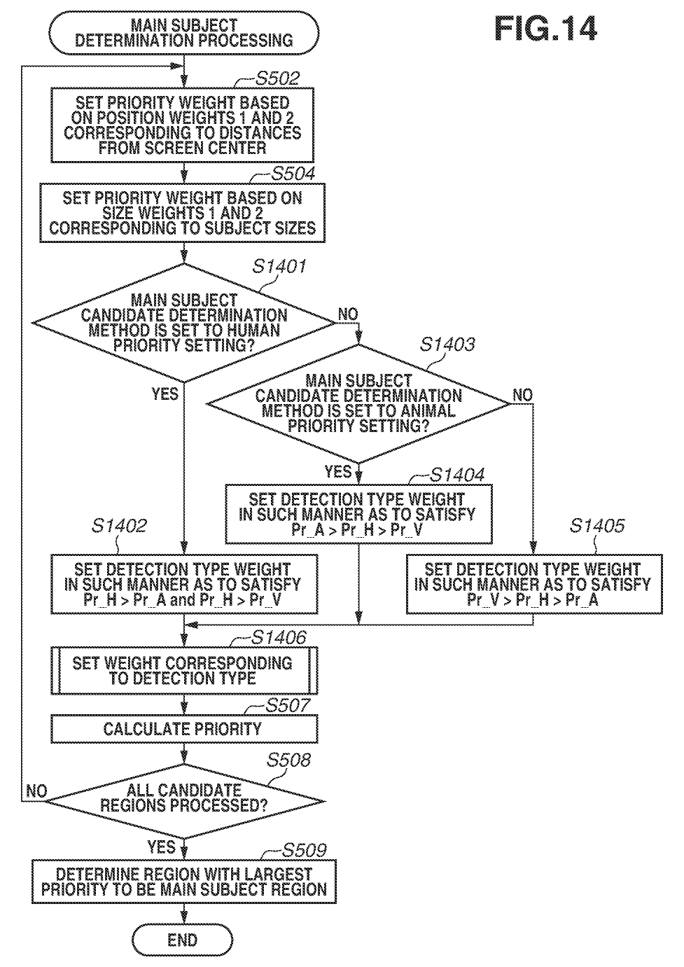

Next, main subject determination processing according to the second embodiment will be described with reference to a flowchart in FIG. 14 and graphs in FIGS. 8A to 8C.

First of all, in step S1401, it is determined whether the setting information of the main subject candidate determination method indicates human priority. In a case where it is determined that the setting information indicates human priority, the processing proceeds to step S1402. In a case where it is determined that the setting information indicates a setting other than the human-prioritized setting, the processing proceeds to step S1403.

Next, in step S1402, detection type weights are set to satisfy Pr_H > Pr_A and Pr_H > Pr_V, and the processing proceeds to step S1406.

Next, in step S1403, it is determined whether the setting information of the main subject candidate determination method indicates animal priority. In a case where it is determined that the setting information indicates animal priority, the processing proceeds to step S1404. In a case where it is determined that the setting information indicates a setting other than the animal-prioritized setting (in the present embodiment, in a case where it is determined that the setting information indicates vehicle priority), the processing proceeds to step S1405.

Next, in step S1404, detection type weights are to satisfy Pr_A > Pr_H > Pr_V, and the processing proceeds to in step S1406.

Next, in step S1405, detection type weights are set to satisfy Pr_V > Pr_H > Pr_A, and the processing proceeds to step S1406.

Next, in step S1406, a weight corresponding to a detection type is set, and the processing proceeds to step S507.

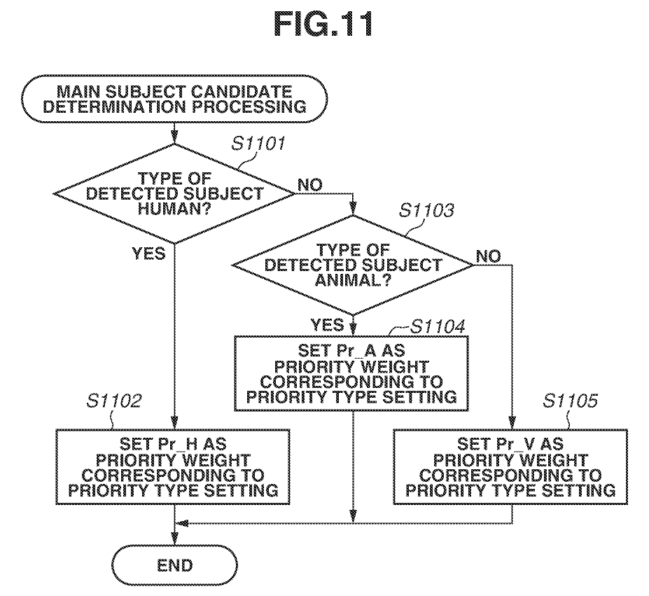

The processing will be described below with reference to FIG. 11.

Next, the details of priorities Pr_H, Pr_A, and Pr_V set in steps S1402, S1404, and S1405 will be described with reference to FIGS. 8A-8C.

FIG. 8A is a diagram illustrating each priority to be set in a case where the setting information of the main subject candidate determination method indicates the human- prioritized setting. When the human-prioritized setting is set, a priority weight Pr_H for humans is set to the largest value, and priorities Pr_A and Pr_V for animals and vehicles are set to a value lower than the priority weight Pr_H. In the present embodiment, because the human-prioritized setting is set, the priorities Pr_A and Pr_V for animals and vehicles are set to the same value, but needs not be always set to the same value as long as these are set to a value lower than the priority weight Pr_H.

The priorities Pr_A and Pr_V for animals and vehicles need to be set in such a manner that the priorities to be set in a case where an animal and a vehicle are detected at the screen center and in the largest size become higher than the priority of the smallest human that is calculated in accordance with a weight corresponding to a distance from the screen center and a size of the subject.

By making a setting in the above-described manner, it becomes possible to set a non-prioritized subject that is likely to be a main subject, as a main subject depending on a scene without taking the trouble to change the setting, while preferentially setting a subject set by the user as a main subject. Thus, there is no need to change the setting each time even in a situation in which the non-prioritized subject is obviously suitable as a main subject depending on a scene, and it becomes possible to put a focus on and control brightness for an intended subject serving as a main subject.

FIG. 8B is a diagram illustrating each priority to be set in a case where the setting information of the main subject candidate determination method indicates the animal- prioritized setting. When the animal-prioritized setting is set, a priority weight Pr_A for animals is set to the largest value, and priorities PrH and Pr_V for humans and vehicles are set to a value lower than the priority weight Pr_A. The priority Pr_H for humans also has a value higher than the priority weight Pr_V for vehicles, which is for non-prioritized subjects, other than humans. This is based on the thought that, even in a case where the animal- prioritized setting is set, a human can often become a main subject, out of human and vehicle that are the same non-prioritized subjects. Thus, it is effective to set a higher value as a priority weight of human than a priority weight of vehicle even when these are the same non-prioritized subjects.

The priority weight PrH for humans that is to be set when the animal-prioritized setting is set or the vehicle-prioritized setting is set is also set to a value higher than the priority weights Pr_A and Pr_V for non-prioritized subjects (animals and vehicles) that are to be set when the human-prioritized setting is set. This is based on the thought that the possibility that a human becomes a main subject when the animal or vehicle-prioritized setting is set is higher than the possibility that an animal or a vehicle becomes a main subject when the human-prioritized setting is set.

FIG. 8C illustrates a setting in which animal and vehicle in FIG. 8B are swapped, and thus the description will be omitted.

Next, a setting of a weight corresponding to a detection type in step S1406 will be described with reference to FIG. 11.

Next, in step S1101, the subject candidate determination unit 120 of the control unit acquires a target human from the detection result acquired in step S201, and determines whether the type of a detected subject is human.

In a case where it is determined that a human has been detected, the processing proceeds to step S1102. In a case where it is determined that an object other than a human has been detected, the processing proceeds to step S1103.

Next, in step S1102, the priority weight PrH for humans is set as a priority weight corresponding to a priority type setting, and the processing ends.

Next, in step S1103, the main subject candidate determination unit 120 acquires a target human from the detection result acquired in step S201, and determines whether the type of the detected subject is animal.

In a case where it is determined that an animal has been detected, the processing proceeds to step S1104. In a case where it is determined that an object other than an animal has been detected (in the present embodiment, in a case where it is determined that a vehicle has been detected), the processing proceeds to step S1105.

Next, in step S1104, the priority weight Pr_A for animals is set as a priority weight corresponding to a priority type setting, and the processing ends.

Next, in step S1105, the priority weight Pr_V for vehicles is set as a priority weight corresponding to a priority type setting, and the processing ends.

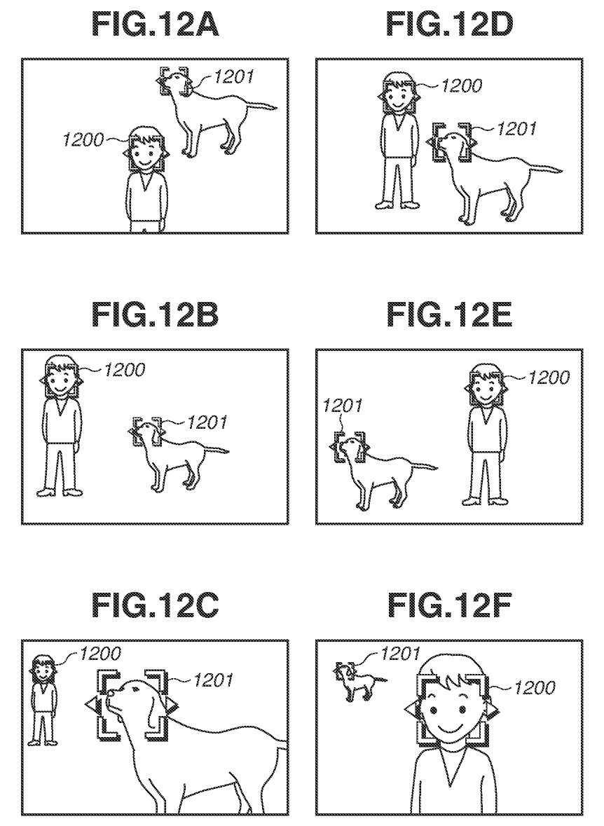

Next, in a case where the setting information of the main subject candidate determination method indicates each setting, the following describes what values the priorities for humans, animals, and vehicles are, and which type of subject is consequently prioritized. Specifically, examples of actual setting values of the position weights 1 and 2, the size weights 1 and 2, and the priorities Pr_A, Pr_V, and PrH will be described with reference to FIGS. 12A to 12F.

It is also assumed that possible values of a distance from the screen center, a size, a position weight, a size weight, and a type weight are normalized with the smallest value set to 0 and the largest value set to 255.

The numeral values to be set are not limited to the following description, and are only required to fall within a range departing from the above description.

In the present embodiment, numerical values are set in such a manner that distance 1 = 20, distance 2 = 200, position weight 1 = 200, position weight 2 = 20, size 1 = 20, size 2 = 200, size weight 1 = 20, and size weight 2 = 200. In a case where the human priority is set, PrH = 255, Pr_A = 100, and PrV = 100 are set. In a case where the animal priority is set, Pr_H = 150, Pr_A = 255, and Pr_V = 100 are set. In a case where the vehicle priority is set, Pr_H = 150, Pr_A = 100, and Pr_V = 255 are set. Coefficients a, (3, and y to be used in priority calculation are set to a = 1, R = 1, and y = 2.

First of all, in a case where the human priority is set, FIG. 12A illustrates a situation in which a human 1200 appears at an approximate center, and an animal 1201 appears at an edge of a screen.

When a distance from the center to the human 1200 is 0, a size of the human 1200 is 50, a distance from the center to the animal 1201 is 200, and a size of the animal 1201 is 30, the priority of the human 1200 is 750 and the priority of animal 1201 is 250. The human 1200 is selected as a main subject, accordingly.

Next, FIG. 12B illustrates a situation in which the animal 1201 appears at an approximate center, and the human 1200 appears at an edge of the screen. Assuming that a distance from the center to the human 1200 is 150, a size of the human 1200 is 40, a distance from the center to the animal 1201 is 0, and a size of the animal 1201 is 50, the priority of the human 1200 becomes 620 and the priority of animal 1201 becomes 450. The human 1200 is selected as a main subject, accordingly.

Next,FIG. 12C illustrates a situation in which the animal 1201 appears in a large size at an approximate center, and the human 1200 appears in a small size at an edge of the screen.

Assuming that a distance from the center to the human 1200 is 200, a size of the human 1200 is 20, a distance from the center to the animal 1201 is 0, and a size of the animal 1201 is 180, the priority of the human 1200 is 550 and the priority of animal 1201 is 580. The animal 1201 is selected as a main subject, accordingly.

Next, in a case where the animal priority is set,FIG. 12D illustrates a situation in which the animal 1201 appears at an approximate center, and the human 1200 appears at an edge of the screen.

Assuming that a distance from the center to the human 1200 is 200, a size of the human 1200 is 30, a distance from the center to the animal 1201 is 0, and a size of the animal 1201 is 50, the priority of the human 1200 is 350 and the priority of animal 1201 is 760. The animal 1201 is selected as a main subject, accordingly.

Next, FIG. 12E illustrates a situation in which the human 1200 appears at an approximate center, and the animal 1201 appears at an edge of the screen.

Assuming that a distance from the center to the human 1200 is 0, a size of the human 1200 is 50, a distance from the center to the animal 1201 is 150, and a size of the animal 1201 is 40, the priority of the human 1200 is 550 and the priority of animal 1201 is 620. The animal 1201 is selected as a main subject, accordingly.

Next, FIG. 12F illustrates a situation in which the human 1200 appears in a large size at an approximate center, and the animal 1201 appears in a small size at an edge of the screen.

Assuming that a distance from the center to the human 1200 is 0, a size of the human 1200 is 180, a distance from the center to the animal 1201 is 200, and a size of the animal 1201 is 20, the priority of the human 1200 is 680 and the priority of animal 1201 is 550. The human 1200 is selected as a main subject, accordingly.

Through the above-described processing, it is possible to set a non-prioritized subject that is likely to be a main subject, as a main subject depending on a scene without taking the trouble to change the setting, while setting an intended subject as a main subject by prioritizing a subject set by the user.

Heretofore, desirable embodiments of the present disclosure have been described, but the present disclosure is not limited to the above-described embodiments, and various modifications and changes can be made within the gist thereof. For example, in the present embodiment, the description has been given using detection results of a face region and a head region of a human, but a combination of a face region and a body region of a human, or a combination of a face region and a head region or a body region of an animal can also be used.

Heretofore, the present disclosure has been described in detail based on desirable embodiments thereof, but the present disclosure is not limited to these specific embodiments, and various configurations without departing from the gist of the disclosure are also included in the present disclosure. Apart of the above-described embodiments can also be appropriately combined.

A case where a program of software implementing the function of the above- described embodiments is supplied to a system or an apparatus including a computer that can execute a program, directly from a recording medium or using wired/wireless communication, and the program is executed is also included in the present disclosure.

Accordingly, a program code to be supplied to and installed on a computer to implement functional processing of the present disclosure on the computer also implements the present disclosure. That is, a computer program for implementing functional processing of the present disclosure is also included in the present disclosure.

In such a case, the format of the program such as an object code, a program to be executed by an interpreter, or script data to be supplied to an operating system (OS) is not limited as long as the function of the program is included.

The recording medium for supplying the program can be, for example, a magnetic recording medium such as a hard disk or magnetic tape, an optical/optical magnetic storage medium, or a nonvolatile semiconductor memory.

A method of supplying the program can also be a method by which a server on a computer network stores a computer program that forms the disclosure, and a client computer that is connected to the server downloads and programs the computer program.

The present disclosure is not limited to the above-described embodiments, and various changes and modifications can be made without departing from the spirit and scope of the present disclosure. Accordingly, the following claims are appended to make public the scope of the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above- described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image processing apparatus comprising:
a first detection unit configured to detect a first subject from an image;
a second detection unit configured to detect a second subject different from the first subject from the image;
a determination unit configured to determine a main subject region that is a region of a main subject, from at least one of detection results obtained by the first detection unit and the second detection unit; and
a setting unit configured to receive switching between a first setting and a second setting, based on an operation from a user,
wherein, in a case where the first setting is set by the setting unit, the determination unit determines a main subject region while setting, as a main subject, a subject of which the first subject has been detected by the first detection unit, in priority to a subject of which the first subject has not been detected by the first detection unit, and
wherein, in a case where the second setting is set by the setting unit, the determination unit determines a main subject region while setting, as a main subject, a subject of which the first subject has not been detected by the first detection unit, and of which the second subject has been detected by the second detection unit in priority to a subject of which the first subject and the second subject have not been detected.

2. The image processing apparatus according to claim 1, wherein the determination unit determines, in the first setting, a main subject region while setting, as a main subject, a subject of which the first subject has been detected by the first detection unit, in priority to a plurality of frames acquired within a predetermined period.

3. The image processing apparatus according to claim 2, wherein the determination unit determines, in the second setting, a main subject region while setting, as a main subject, a subject irrespective of whether the subject is a subject of which the first subject has been detected by the first detection unit, in a plurality of frames acquired within a predetermined period.

4. The image processing apparatus according to claim 1, wherein the determination unit calculates, in the second setting, a priority of a subject while setting a larger weight for
at least either one of a position and a size of a subject than that in the first setting, and determines a main subject based on the priority.

5. The image processing apparatus according to claim 4,. the determination unit lowers, in the second setting, a weight to be added to the priority, for a subject that continues a state in which the first subject has not been detected by the first detection unit, for a predetermined time, before a lapse of the predetermined time.

6. The image processing apparatus according to claim 4, wherein the determination unit sets, in the second setting, a larger weight in a case where the first subject has not been detected by the first detection unit, than that in the first setting.

7. The image processing apparatus according to claim 1,
wherein the first subject is a part of a face of a subject, and
wherein the second subject is a part different from the face that includes a head, a body trunk, and a whole body of the subject.

8. The image processing apparatus according to claim 1, wherein the first subject is at least a part of a human, and
wherein the second subject is at least a part of a subject different from the human that includes an animal and a vehicle.

9. A control method of an image processing apparatus, the control method comprising:
detecting, as a first detection, a first subject from an image;
detecting, as a second detection, a second subject different from the first subject from the image;
determining a main subject region that is a region of a main subject, from at least one of detection results obtained in the first detection and the second detection; and
setting receiving switching between a first setting and a second setting, based on an operation from a user,
wherein, in a case where the first setting is set in the setting, the determining determines a main subject region while setting, as a main subject, a subject of which the first subject has been detected in the first detection, in priority to a subject of which the first subject has not been detected in the first detection, and
wherein, in a case where the second setting is set in the setting, a main subject region is determined while setting, as a main subject, a subject of which the first subject has not been detected in the first detection, and of which the second subject has been detected in the second detection, in priority to a subject of which the first subject and the second subject have not been detected.
